(19) United States
(12) Patent Application Publication
(10) Pub. No.: US 2009/0160670 A1
(43) Pub. Date: Jun. 25, 2009

(54) Object locator system

(76) Inventor: Michael Sipple, Tustin, CA (US)

Correspondence Address: Michael Bell, 2931 Hickory Place, Fullerton, CA, 92835, US

(21) Appl. No.: 12/156,526

(22) Filed: Jun. 2, 2008

Related U.S. Application Data
(60) Provisional application No. 61/008,897, filed on Dec. 21, 2007.

(51) Int. Cl. H04Q 5/22

(52) U.S. Cl. 340/686.1; 340/10.4

(57) ABSTRACT

An object locator system comprises an activation unit and a remote locator where the remote locator may be attached to an easily misplaced object, such as a key or key-ring. The activation unit comprises additional functionality to induce the operator to carry it routinely so that it might be available at distant sites if needed. In one embodiment, the activation unit comprises a cellular telephone. In another embodiment, the activation unit comprises a wrist watch with an integral transmitter. The activation unit, when triggered, generates an activating signal. The remote locator receives the activating signal and announces its location. Communication from the activation unit to the remote locator may be direct or indirect, and may be via radio frequency electromagnetic, optical, or acoustic means.

### PRIORITY

This application claims the benefit of priority to U.S. provisional patent application 61/008,897 filed Dec. 21, 2007.

### BACKGROUND OF THE INVENTION

1. Field of the Invention

This invention concerns the field of misplaced object location.

2. Background Art

People often misplace or lose small, valuable objects. While searching, recollection of the loss location, or accident may ultimately reveal the object's location, none of these is satisfactory when the objects are needed within a limited time. Others have provided aids for location of lost objects, but these aids do not fully address the problem. For example, a bell on a key ring that chimes when shaken is useful to find the keys if the keys are left inside a bag. This is not useful if the keys sit on a desk.

Others have devised more sophisticated systems; U.S. Pat. No. 5,680,105 is representative of such art. It discloses an object locator system with a collection of activation units and a collection of response units, where each response unit may be attached to an object to be located. Activation units and response units are associated in pairs with each member of the pair sharing an identifying code. The activation unit contains a radio frequency (“RF”) tansmitter which communicates with an RF receiver in a response unit. In use, an operator triggers the activation unit to emit an encoded RF signal, and the associated response unit receives the signal and responds by sounding a beeper. The operator then tracks the sound of the beeper to locate the misplaced object.

U.S. Pat. No. 6,366,202 discloses a bi-directional system that differs in some regards from the above, but shares its limitations. Here, the activation unit and receiver unit are substantially identical. They communicate using acoustic transceivers rather than RF, and each unit is capable of performing either the activation or the response unit function.

A major limitation for the general application of such devices is the necessity of transporting both an activation unit and a response unit to a location where objects are misplaced. While this is not of much concern if the object, such as a television remote control, is unlikely to leave the confines of a dwelling, it is very much of concern where the object is not so confined. In particular, a ring of keys would commonly be employed to operate an automobile which moves to distant locations. If the keys were lost in such a location, the operator would be unable to return home to fetch the activation unit. While this could be remedied by routinely carrying the prior art activation unit, an individual who has the self-discipline to carry such a unit around at all times is unlikely to be the same individual who misplaces his or her keys. One with a propensity to lose his or her keys is likely not to remember to carry the activation unit at all times or may misplace the activation unit also.

A further limitation of the prior art locator systems is the limited allowable separation distance between the activation unit and the response unit. RF systems as in the first illustration are typically limited to a range of about 80 feet. The acoustic system of the second illustration purports to be limited to a range of about 300 feet. While these ranges may be reasonable if the only indicator on the response unit were an audible one, they place an undue limitation if the response unit uses visual indicators, since reasonable visual indicators may be detectable at a greater distance. Further, should one who misplaced the object enlist the aid of others to aid in the object's recovery, the limited range of the activation signal means that a search must be confined to a relatively small zone surrounding the holder of the activation unit. With a locator that does not have the limited range of the prior art, a team of seekers could spread over a large area to locate a lost object as soon as the response unit responds. A response unit that responds far from the activation unit might also induce a cooperative passerby to recover the object and to contact its owner.

It is an object of this invention to provide the benefits of a wireless object location system without the requirement to carry an additional device which has the sole purpose of locating a misplaced object. It is a further object of the invention to provide an object locator system capable of activating a response unit even if the response unit is at relatively large distance from the activation unit.

### SUMMARY OF THE INVENTION

The below-described embodiments illustrate various adaptations of the invention. From the description of these embodiments, other aspects of the invention can be readily fashioned by making slight adjustments or modifications to the components and steps discussed below.

Unless otherwise defined, all technical terms used herein have the same meaning as commonly understood by one of ordinary skill in the art to which this invention belongs.

This invention comprises a system for locating lost or misplaced objects. The system comprises an activation unit and a remote locator, where the activation unit has additional functionality. The activation unit generates an activating signal in response to an operator's action. The additional functionality is such that an operator would be inclined to carry the activation unit most places he or she traveled so that, should the locator function be required, it would be readily available.

In this document, the words “activating signal” refer to the signal that causes the remote locator to announce its presence. In cases where the signal is indirect, the words refer to both the initial signal generated by an activation unit and to any subsequent signal generated by an indirect signaling component such as a cellular telephone switching system or a radio frequency paging system. The word “trigger” means an operator's action to cause an activation unit to produce an activating signal.

In one embodiment, the system includes an object locator system comprising:

a) a cellular telephone capable of generating an activating signal, and

b) a remote locator in wireless communication with the cellular telephone and responsive to the activating signal

where the remote locator indicates the location of the object. In this embodiment, the cellular telephone performs the role of the activation unit.

In another embodiment, the system includes an object locator system comprising:

a) a wrist watch capable of generating an activating signal, and

b) a remote locator in wireless communication with the wrist watch and responsive to the activating signal

where the remote locator indicates the location of the object. In this embodiment, the wrist watch performs the role of the activation unit.

In either of these embodiments, the activation unit may communicate to the remote locator through any of a variety of wireless communication methods. These methods include radio frequency electromagnetic waves, optical signals, or acoustic signals.

In some embodiments, the locator device is capable of responding to the activating signal when the remote locator is at a distance greater than about 500 feet from the activation unit.

In some embodiments, the locator device is capable of responding to the activating signal when the remote locator is at a distance greater than about one mile from the activation unit. Performance at this distance generally requires indirect communications between the activation unit and the remote locator.

In one embodiment, the remote locator of the invention comprises:

a) a controller;

b) a signal receiver operatively coupled to the controller;

c) an annunciator operatively coupled to the controller;

d) a power source electrically coupled to the controller, and

e) a housing substantially enclosing components a), b), c), and d).

In some embodiments, the remote locator further comprises a transmitter capable of communicating with a cellular telephone switching system to indicate its presence in a particular cell as described above.

### BRIEF DESCRIPTION OF THE DRAWINGS

FIG. 1 illustrates an embodiment of a remote locator attached to a key-ring and a cellular telephone acting as the activation unit with indirect communication through a cellular telephone switching system.

FIG. 2 illustrates a remote locator attached to a key-ring and a cellular telephone acting as the activation unit with indirect communication through a radio frequency paging system.

FIG. 3 illustrates a remote locator attached to a key-ring and a cellular telephone acting as the activation unit with direct communication to the remote locator.

FIG. 4 illustrates a remote locator attached to a key-ring and a wrist-watch acting as the activation unit with indirect communication through a radio frequency paging system.

FIG. 5 illustrates a block diagram of an embodiment of the remote locator.

In the figures, like items are designated by like numerals.

### DETAILED DESCRIPTION

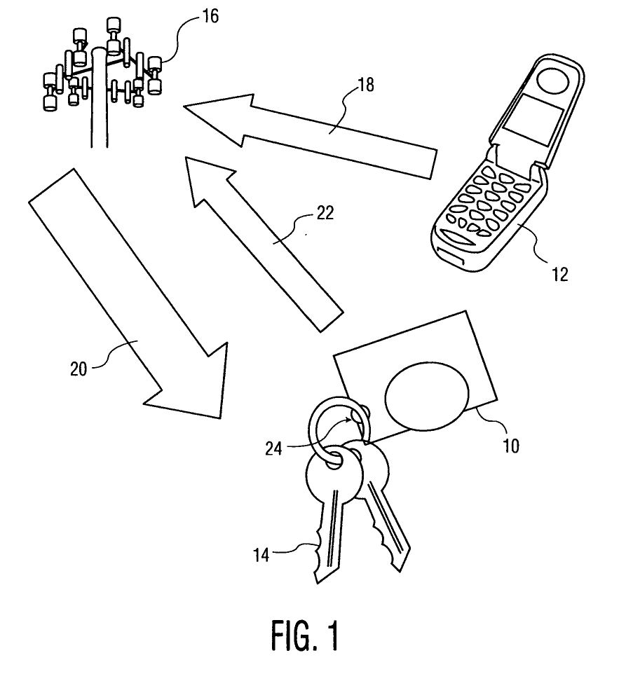

In FIG. 1, cellular telephone 12 communicates to cellular telephone switching system 16 via RF signal 18. Cellular telephone switching system 16 communicates to remote locator 10, shown attached to key-ring 14 through attachment point 24, via RF signal 20. Upon receipt of signal 20, remote locator 10 announces its position. Remote locator 10 periodically communicates to cellular telephone switching system 16 via RF signal 22 to indicate its presence in a particular cell. In this embodiment, the activating signal comprises the two RF signals 18 and 20.

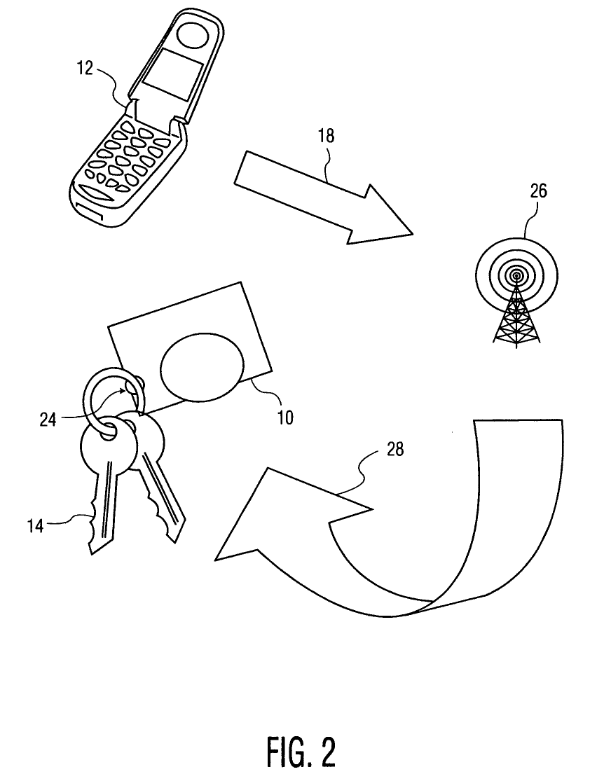

In FIG. 2, cellular telephone 12 communicates to non-celluar radio frequency paging system 26 via RF signal 18. Paging system 26 communicates to remote locator 10 via RF signal 28. Upon receipt of signal 28, remote locator 10 announces its position. In this embodiment, the activating signal comprises the two RF signals 18 and 28.

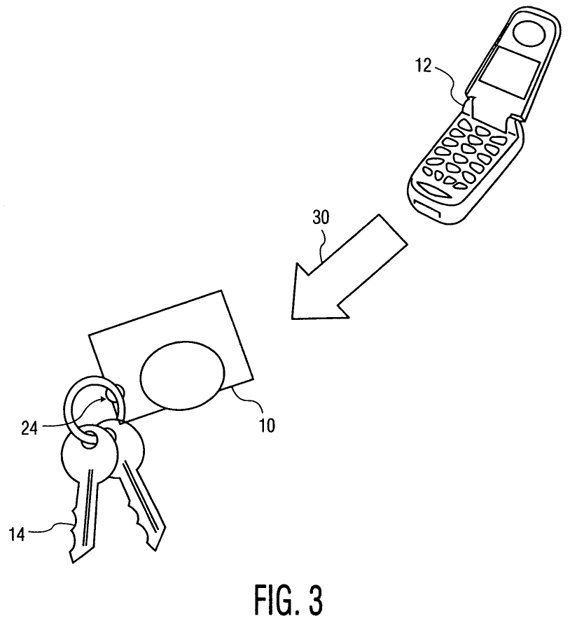

In FIG. 3, cellular telephone 12 communicates directly to remote locator 10 via signal 30. Upon receipt of signal 30, remote locator 10 announces its position. In this embodiment, the activating signal comprises signal 30. Signal 30 may be an RF signal, an acoustic signal or an optical signal.

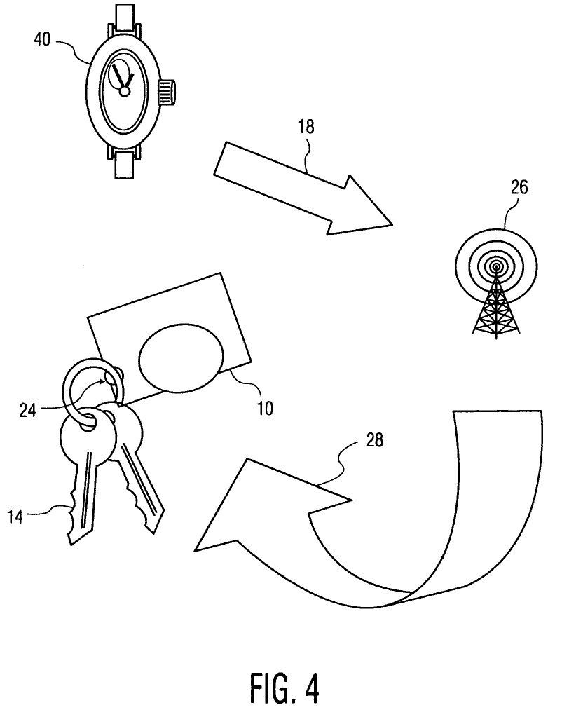

In FIG. 4, transmitting wrist watch 40 communicates to non-cellular paging system 26 via RF signal 18. Paging system 26 communicates to remote locator 10 via RF signal 28. Upon receipt of signal 28, remote locator 10 announces its position. In this embodiment, the activating signal comprises the two RF signals 18 and 28.

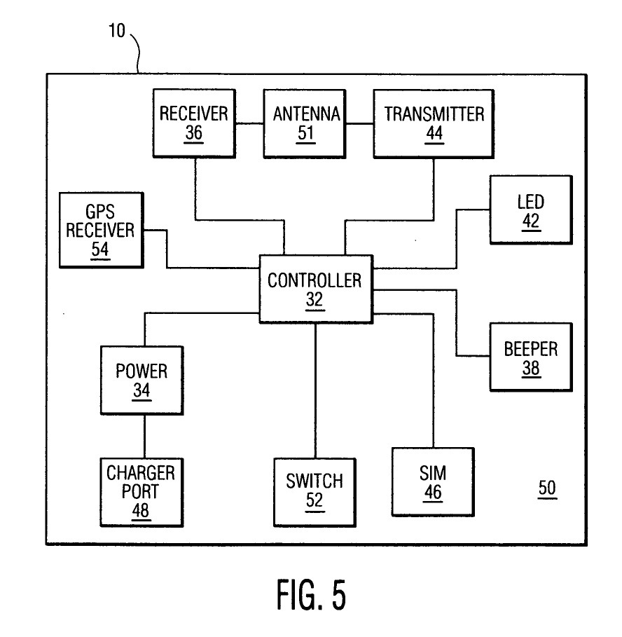

In FIG. 5, remote locator 10 comprises housing 50 packaging controller 32, power source 34, receiver 36, switch 52, light emitting diode (“LED”) 42, and beeper 38. This embodiment includes transmitter 44 and SIM 46 (Subscriber Identity Module, a “Smart Card” chip that establishes a unique identifier for the remote locator). SIM 46 identifies the remote locator to a cellular telephone switching system; transmitter 44 allows the remote locator to communicate with the cellular telephone switching system. Power source 34, typically a battery and associated regulatory electronics known in the art, is electrically connected to charger port 48 to allow recharge of the power source. Power source 34 is also electrically connected to controller 32 and to all other electronic components in remote locator 10 that require power to function. Controller 32, typically a single chip microcomputer such as the Texas Instruments MSP430 family microcontroller, is electrically connected to power source 34, switch 52, receiver 36, LED 42, beeper 38, transmitter 44, and SIM 46. These electrical connections allow controller 32 to operate each of the other components to perform the remote locator functions. Switch 52 allows the operator to signal the controller to cancel an in-progress annunciation. LED 42 and beeper 38 together form the annunciator that indicates the remote locator's location to operators. Antenna 51 connects to receiver 36 and to transmitter 44 if present. Optional Global Positioning Satellite (“GPS”) receiver 54 is present in some embodiments that include two-way communications from the remote locator. GPS receiver 54 supplies remote locator location information that may be transmitted by controller 32 using transmitter 44.

The communication between activation unit and remote locator may be direct or indirect. If it is direct, the activation unit generates the activating signal, and the remote locator announces its presence upon receipt of the signal. The activating signal may be a radio frequency signal, such as commonly used in cellular telephone “walkie-talkie” functionality. Other radio frequency signals useful in the invention include “Bluetooth®” signals designed to communicate with local accessories, “Wi-Fi” signals designed to communicate with local data networks, “Wi-Max” or “Wi-MAN” signals designed to communicate wireless broadband networks, 3G or 4G signals for future wireless communications, standard cellular telephone signals, or a specialized signal expressly for this purpose. Preferably, the activating signal (if it is a direct RF signal) is any signal but the last mentioned. This allows a standard cellular telephone device to serve as the activation unit.

The activation signal may also be an optical signal or an acoustic signal. Optical signaling capability is an increasingly common capability of cellular telephones. Acoustic signaling capability is an obligate capability of a cellular telephone; it serves the functions of speaker and ringer. In some embodiments a custom “ringtone” may be loaded into a cellular telephone, where the ringtone encodes an identifier unique to the remote locator device.

In embodiments where the communication is indirect, the communication may be through the intermediary of a cellular telephone switching system. A cellular telephone switching system serves a large geographic area through a network of cells containing short-range transceivers and antennae. Such a cellular telephone switching system generally requires that the system be aware of which cell contains the remote locator. This knowledge may be derived from periodic communications from a transmitter in the remote locator where the communications inform the cellular telephone switching of the remote locator's location. This communication is indicated schematically as 22 in FIG. 1.

Alternatively, the cellular telephone switching system with knowledge of the location of the activation unit may rely upon that knowledge to transmit the activating signal to the same cell that contains the activation unit, and, in some embodiments, to adjacent or nearby cells. This is particularly appropriate where the activation unit comprises a cellular telephone as the cellular telephone switching system already requires knowledge of the location of a cellular telephone for that cellular telephone to function. An advantage of this latter embodiment is that the remote locator unit need not be equipped with the relatively bulky, expensive, and power-consuming transmitter. This reduces cost for the remote locator and extends battery life.

In such indirect communications systems, the activation signal comprises two parts: an upstream signal by which the activation unit communicates with the switching system, and a downstream signal 20 by which the switching system communicates with the remote locator.

Alternatively, indirect communication may be through the intermediary of a non-cellular radio frequency paging system. Such a system has the benefit of serving a large geographical area (hundreds to thousands of square miles) without the requirement of an activating signal transmitted from the vicinity of the remote locator and without the requirement that the remote locator expend limited battery power to periodically contact a cellular telephone switching system.

In still another embodiment, indirect communication may be through the intermediary of a local transceiver which covers only a limited area, such as a “Wi-Fi” radio frequency communication transceiver compliant with IEEE standard 802.11b, 802.11g, 802.11n, or any similar or successor standards relating to local wireless networking.

In still another embodiment, indirect communication may be through the intermediary of a local transceiver which covers a more extended but still limited area, such as a “Wi-Max” or “Wi-MAN” radio frequency communication transceiver compliant with any of IEEE standards labeled 802.16, or any similar or successor standards relating to broadband wireless networking.

The controller is preferably a microprocessor or single chip microcomputer, but may be implemented as a state machine or FPGA. The design integration, and control of such components is well known in the art.

The receiver, and the transmitter if present, must conform to the nature and intensity of the activating signal. Thus, an acoustic transducer such as a piezoelectric modulator, microphone, or speaker may be used when the activating signal is acoustic, a radio frequency receiver may be used when the activating signal is a radio frequency signal, and a phototransistor, photodiode, or other optical sensor may be used when the signal is optical. The design, integration, and control of such components is well known in the art.

In some embodiments, the annunciator comprises a visual indicator, such as a light emitting diode. Such a visual indicator may be illuminated constantly once the remote locator receives an activating signal, or it may be modulated to increase its visibility. A particularly useful method of modulation is to flash the indicator fully on and fully off at a frequency of about one-tenth Hertz to about 20 Hertz, preferably at about one-half Hertz to about five Hertz, and most preferably at about two Hertz.

In some embodiments, the annunciator comprises an audio indicator such as a beeper, buzzer, or speaker. Preferably, the annunciator comprises both an audio indicator and a visual indicator. Receipt of the activation signal produces a combination of light and sound that signals tot he operator the location of the remote locator.

The power source preferably comprises a battery. In some embodiments the battery is a rechargeable battery. This latter is particularly important where the remote locator communicates through the intermediary of a cellular telephone switching system and thus must periodically transmit a signal to the cellular telephone switching system to indicate in which cell it is present. Such transmissions consume considerable power. In some embodiments the invention includes a battery charger operating either from electrical mains power or from “cigarette lighter” power ports common in automobiles.

In some embodiments, the remote locator includes an indication of the charge state of the battery. This indication may take many forms. For example, an audio indicator may “chirp,” produce an intermittent sound, when the battery charges falls below a threshold level. The chirping indicates to the user that the remote locator should be recharged. In other embodiments, the remote locator includes a visible indication of battery charge state. It may produce an intermittent light flash equivalent to the audio chirp, or it may illuminate a light source such as an LED, where the intensity, color, flash rate, or shape indicates the state of the charge. In still other embodiments, switch 52 may also act as a battery test switch. Closure of the switch when the remote locator is not activated triggers the controller to cause the annunciator to indicate the state of the battery charge.

The housing packages the other components of the remote locator. In some embodiments, the housing includes an attachment, such as a piercing or ring, so that the remote locator may be attached to a key, a key-ring, or the like. Other attachment methods for other types of objects are well known in the art. In some embodiments, the housing has an opening to permit exchange of a battery. Other embodiments are pierced to allow a recharging unit to gain electrical contact with the power source so that battery may be recharged in situ.

Preferably, the object locator system associates a unique identifier or code with each remote locator. This prevents inadvertent activation of other remote locator units. Preferably the code is a digital code. Once an operator triggers the activation unit, the activation unit must generate, and the remote locator must recognize, the unique code assigned. In the remote locator, this recognition function is performed by the controller, which compares the code received by the receiver to a pre-stored reference code in a storage location such as a SIM card or other memory storage location. If the received code and the reference code match, the controller activates the annunciator to attract the attention of an operator.

Once the controller in the remote locator activates the annunciator, the annunciator may remain active for a predetermined length of time, or until deactivated. Preferably, the controller supports both functions. The controller causes annunciation to continue for a limited duration to spare the remote locator power source. This limited duration is preferably less than one hour, more preferably less than ten minutes, and most preferably less than about two minutes. Preferably, the remote locator may be activated anew either before or after the expiry of the limited duration. Once the remote locator is found, its annunciation may be deactivated by waiting for the expiry of the limited duration of activation, or, more preferably, by receipt of a deactivating signal from the activation unit or by the operator engaging a switch on the remote locator where the switch is coupled to the controller.

In the Summary of the Invention above and in the Detailed Description of the Invention below, reference is made to particular features (including method steps) of the invention. It is to be understood that the disclosure of the invention in this specification includes all appropriate combinations of such particular features. For example, where a particular feature is disclosed in the context of a particular aspect or embodiment of the invention, that feature can also be used, to the extent appropriate, in combination with and/or in the context of other particular aspects and embodiments of the invention, and in the invention generally.

In describing and claiming the invention below, the following definitions (in addition to those already given) are used. The term “comprises” (and grammatical variations thereof) in relation to methods, materials, things etc is used herein to mean that the methods, materials, things etc. can optionally include, in addition to the steps, features, components, etc. explicitly specified after the term “comprises” (and grammatical variations thereof), other steps, features, ingredients, etc. Where reference is made herein to a method comprising two or more steps, the steps can be carried out in any order, or simultaneously, except where the context excludes that possibility.

I claim:

1. A object locator system comprising:
a) a cellular telephone capable of generating an activating signal, and
b) a remote locator in wireless communication with the cellular telephone and responsive to the activating signal
where the remote locator indicates the location of the object.

2. The object locator system of claim 1 wherein the remote locator is capable of responding to the activating signal when the remote locator is at a distance greater than about 500 feet from the cellular telephone.

3. The object locator system of claim 1 wherein the remote locator responds to the activating signal from the cellular telephone through a cellular telephone switching system operating within a plurality of cells.

4. The object locator system of claim 3 wherein the activating signal comprises an upstream signal generated by the cellular telephone and received by the cellular telephone switching system in at least one of the plurality of cells, and a downstream signal generated by the cellular telephone switching system, where the cellular telephone switching system selects in which of the plurality of cells to generate the downstream signal based upon in which of the plurality of cells the cellular telephone switching system received the upstream signal.

5. The object locator system of claim 4 wherein the cellular telephone switching system generates the downstream signal in the same cell as the cellular telephone switching system received the upstream signal.

6. The object locator system of claim 1 wherein the activating signal is selected from a group consisting of electromagnetic signals, acoustic signals, and optical signals.

7. The object locator system of claim 1 wherein the remote locator comprises:
a) a controller;
b) a signal receiver operatively coupled to the controller;
c) an annunciator operatively coupled to the controller;
d) a power source electrically coupled to the controller, and
e) a housing substantially enclosing components a), b), c), and d).

8. The object locator system of claim 7 wherein the remote locator further comprises a transmitter capable of communicating with a cellular telephone switching system.

9. The object locator of claim 7 wherein the remote locator further comprises a GPS receiver.

10. The object locator system of claim 7 wherein the controller comprises a unique identifier.

11. The object locator system of claim 7 wherein the annunciator comprises a visual indicator.

12. The object locator system of claim 11 wherein the visual indicator comprises a light emitting diode.

13. The object locator system of claim 7 wherein the annunciator comprises an audio indicator.

14. The object locator system of claim 7 wherein the power source comprises a rechargeable battery.

15. The object locator system of claim 7 wherein the power source comprises a primary battery.

16. The object locator system of claim 7 wherein the housing comprises an attachment for a key.

17. An object locator system comprising:
a) a wrist watch capable of generating an activating signal, and
b) a remote locator in wireless communication with the wrist watch responsive to the activating signal
where the remote locator indicates the location of the object.

18. The object locator system of claim 17 wherein the remote locator is capable of responding to the activating signal when the remote locator is at a distance greater than about 500 feet from the wrist watch.

19. The object locator system of claim 17 wherein the remote locator is capable of responding to the activating signal when the remote locator is at a distance greater than about one mile from the wrist watch.

20. The object locator system of claim 17 wherein the remote locator responds to the activating signal from the wrist watch through a non-cellular radio frequency paging system.
